(19) United States
(12) Patent Application Publication
(10) Pub. No.: US 2004/0259709 A1
(43) Pub. Date: Dec. 23, 2004

(54) Packaging sheet material for packaging pourable food products

(76) Inventors: Lorenzo Guidotti, Modena (IT); Alvaro Melissa, Casalgrande (IT); Egidio Messori, Rubiera (IT); Richard Norenstam, Kavlinge (SE)

Correspondence Address: BURNS DOANE SWECKER & MATHIS L L P, POST OFFICE BOX 1404, ALEXANDRIA, VA, 22313-1404, US

(21) Appl. No.: 10/491,987

(22) PCT Filed: Oct. 31, 2002
(86) PCT No.: PCT/EP02/12207

(30) Foreign Application Priority Data
Nov. 2, 2001 (IT) T001A001043

(51) Int. Cl. B31F 7/00

(52) U.S. Cl. 493/356

(57) ABSTRACT

A sheet material (2) for packaging food products and having a number of fold lines (4) formed by compression creasing, so that the fold lines (4) have a recessed profile on the face (23) of the material (2) eventually facing outwards of the package (17) and bearing a printed decoration (5), and a nonconvex profile on the opposite face (25); the decoration (5) has a printed area (36) at least partly enclosing one or more fold lines (37), so as to define, with them and by contrast, an optically detectable register mark (18).

### TECHNICAL FIELD

The present invention relates to a packaging sheet material for packaging pourable food products.

### BACKGROUND ART

Materials are known for packaging pourable food products, such as fruit juice, wine, tomato sauce, pasteurized or long-storage (UHT) milk, etc.

The packages are formed from a continuous roll-fed web of packaging material, which may be cut to form blanks or longitudinally sealed to form a tube of packaging material.

The packaging material has a multilayer structure comprising a layer of paper material covered on both sides with layers of heat-seal material, e.g. polyethylene, and, in the case of aseptic packages for long-storage products, such as UHT milk, also comprises a layer of barrier material defined, for example, by an aluminium foil, which is superimposed on a layer of heat-seal plastic material and in turn covered with another layer of heat-seal plastic material eventually defining the inner face of the package contacting the food product.

To produce aseptic packages, according to one well-known technique, the web of packaging material is unwound off a reel and fed through an aseptic chamber in which it is sterilized, e.g. by applying a sterilizing agent such as hydrogen peroxide, which is later vaporized by heating and/or by subjecting the packaging material to radiation of appropriate wavelength and intensity.

The sterilized web is then folded into a cylinder and sealed longitudinally to form, in known manner, a continuous, vertical, longitudinally sealed tube. The tube of packaging material, in other words, forms an extension of the aseptic chamber, and is filled continuously with the pourable food product and then fed to a form-and-seal unit for forming the individual packages and on which pairs of jaws grip and seal the tube transversely to form pillow packs.

The pillow packs are then separated by cutting the sealing portion between the packs, and are fed to a final folding station where they are folded mechanically into the shape of the finished packages.

The packages are formed by folding the packaging material along fold lines “creased” into the material creasing is performed by two creasing rollers having respective work surfaces with respective raised and recessed lines perfectly aligned to subject the material locally to deformation having a substantially U-shaped cross section, and with substantially no change in the thickness of the material. The creased packaging material springs partly back to its original shape, so that the permanent fold lines in the material are shallower than when creased, and have a concave profile on one face of the material, normally the one facing outwards of the package, and a convex profile on the opposite face.

Conventional creasing has several drawbacks.

Firstly, the equipment required is extremely expensive, owing to the high degree of precision involved in producing the work surfaces of the creasing rollers to ensure they mate perfectly and do not damage the material.

Secondly, local delamination of the material may occur when folding the material along the fold lines to form the packages.

### DISCLOSURE OF THE INVENTION

It is an object of the present invention to provide a packaging material with none of the aforementioned drawbacks typically associated with known materials.

According to the present invention, there is provided a sheet material for packaging food products and having a number of fold lines; characterized in that said fold lines are compression lines having a concave profile on one face of the material, and a nonconvex profile on an opposite face.

According to the invention, the fold lines can be formed by means of a creasing roller with projections, and a reaction roller having a smooth work surface, i.e. without the recesses which, in conventional creasing, act as a “die” for the projections on the other roller. The cost of the creasing equipment is thus greatly reduced.

Moreover, since the material is creased by straightforward compression as opposed to cutting action, the problems and hazards posed by delamination are reduced.

Another problem posed by known creasing methods is the following:

Though formation of the packages must match the fold lines, packaging material feed on the forming machine is normally controlled on the basis of register marks printed on the material.

The reason for this lies in conventional direct optical detection of the fold lines still posing problems for which a satisfactory solution has not yet been devised.

Creasing and printing are performed at different stages in the material production cycle, so that register tolerances between the two are inevitable. Using printed register marks as position references for operations which should match the fold lines therefore inevitably results in errors.

According to a preferred embodiment of the invention, the material comprises optically detectable register marks defined by compression-creased lines.

As compared with known creasing methods, compression creasing provides for obtaining much clearer compression lines which are detectable optically and can therefore be used as register marks.

According to a preferred embodiment of the invention, the material also comprises a decoration having a printed area at least partly enclosing one or more compression-creased fold lines, so that the fold lines in the printed area define optically detectable, “negative-printed” marks.

When printed using any known printing technique, the packaging material is compressed between a print cylinder and a counter-cylinder. If a conventional creasing method is used, the convex profile of the crease on the counter-cylinder side produces thrust resulting in accidental, undesired contact between the packaging material and print cylinder on the concave side of the crease line, thus resulting in lines with blurred profiles which are substantially undetectable optically.

Compression creasing, on the other hand, also produces a flat or slightly concave profile on the face of the packaging material contacting the counter-cylinder, thus eliminating thrust, and the concave opposite side of the fold line is definitely ink-free, thus obtaining a high-contrast mark perfectly detectable by an optical sensor.

### BRIEF DESCRIPTION OF THE DRAWINGS

A number of non-limiting embodiments of the present invention will be described by way of example with reference to the accompanying drawings, in which:

FIG. 1 shows, schematically, a machine for producing aseptic packages from a web of sheet material in accordance with the present invention;

FIG. 2 shows a portion of a sheet packaging material in accordance with the present invention;

FIGS. 3 and 4 show, schematically, respective steps in a method of producing the FIG. 2 material;

FIG. 5 shows a portion of a packaging material in accordance with a further embodiment of the invention.

### BEST MODE FOR CARRYING OUT THE INVENTION

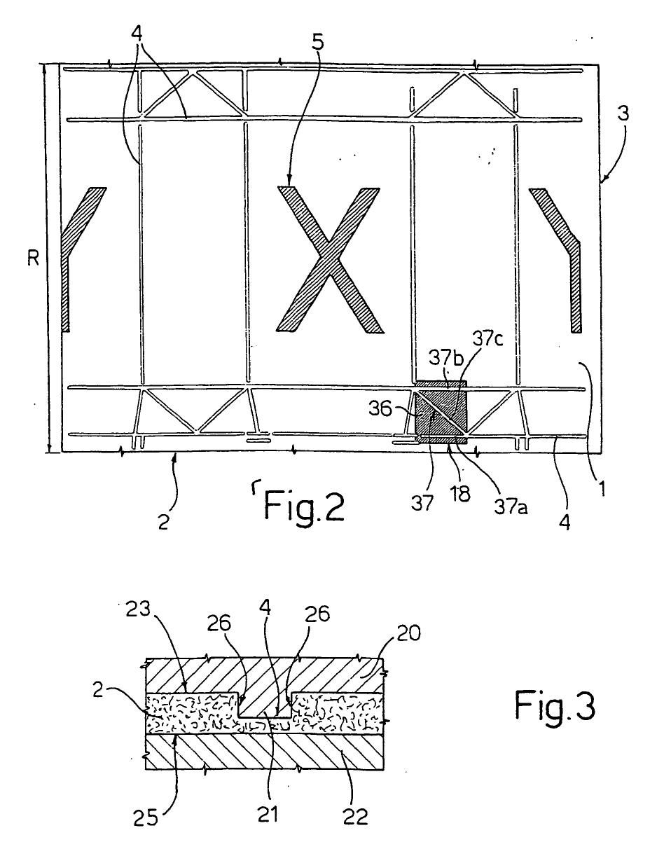

Number 1 in FIG. 2 indicates a portion of a sheet packaging material 2 fed in the form of a continuous web 3.

Web 3 of material 2 comprises a number of fold lines 4 and a printed decoration 5, which are repeated at intervals R equal to the length of material required to produce one package.

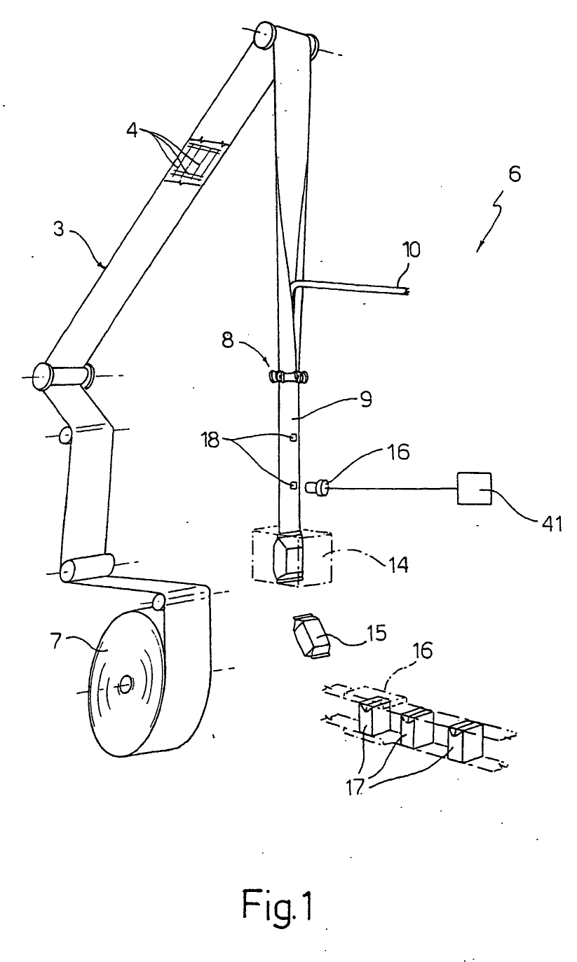

Web 3 can be used on a machine 6, shown schematically in FIG. 1, for producing aseptic packages, and on which web 3 is unwound off a reel 7 and fed through an aseptic chamber (not shown), where it is sterilized, and through an assembly 8 by which it is folded and sealed longitudinally to form, in known manner, a continuous vertical tube 9.

Tube 9 of packaging material is filled continuously with the pourable food product by means of a known filling device 10, and is then fed to a forming and transverse sealing station 14 where it is gripped between pairs of jaws (not shown) which seal the tube transversely to form pillow packs 15.

Pillow packs 15 are then separated by cutting the sealing portion between the packs, and are fed to a final folding station 16 where they are folded mechanically to form the finished packages 17.

The packages are formed by folding the material along fold lines 4, and by controlling material feed by means of an optical sensor 16 for “reading” register marks 18 located on the material at intervals R.

According to the present invention, fold lines 4 are defined by compression lines formed by means of a compression creasing process (FIG. 3).

More specifically, material 2 is compressed between a creasing roller 20 the profile of which is shown partly, in plan form, in FIG. 2 and comprises a number of projections 21 corresponding with fold lines 4- and a smooth reaction roller 22, i.e. with no cavities corresponding with projections 21. Conveniently, roller 20 operates on the face 23 of the material defining the outer surface of the package, i.e. on which decoration 5 is printed, and roller 22 on the opposite face 25. The height of projections 21 ranges between 50 and 90%, and is preferably about 80%, of the thickness of material 2. The thickness of the material is reduced by the same percentage during compression, after which, the material recovers partly, but retains a permanent compressive set. The residual depth of the compression lines conveniently ranges between 30% and 60% of the thickness of material 2, and equals about 50% of the thickness when roughly 80% deformation is imposed during creasing.

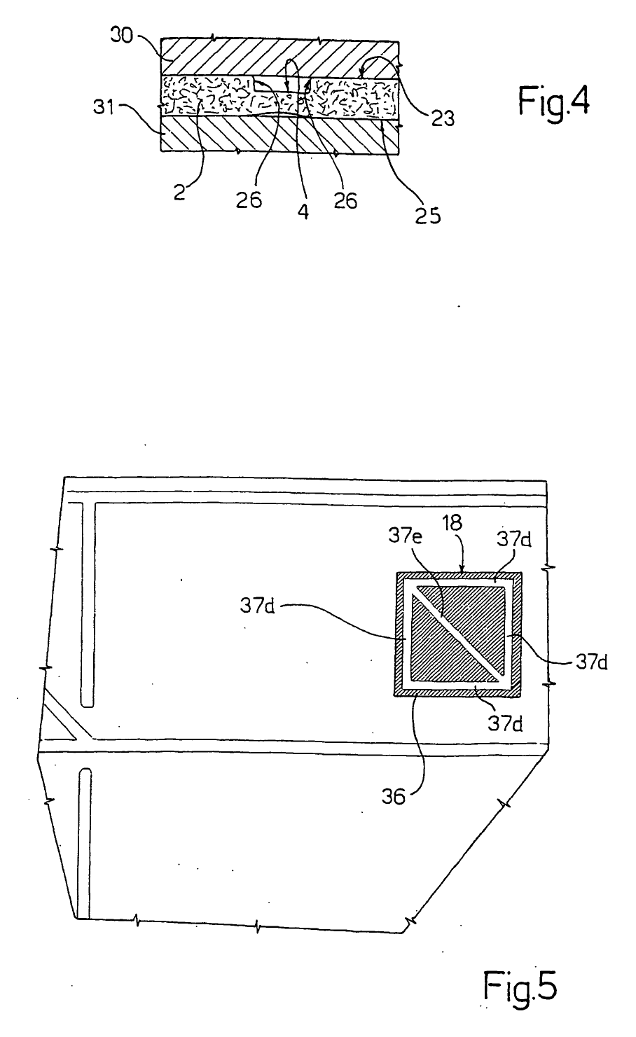

As shown clearly in FIG. 4, compression lines 4 have a recessed profile, defined laterally by step sides 26, on face 23 of material 2, and a substantially flat or slightly concave profile on the opposite face 25.

FIG. 4 also shows, schematically in plan form, the profiles of a print roller 30 and a counter-roller 31 respectively contacting faces 23 and 25 of material 2 at a compression line 4.

As shown clearly in FIG. 4, the substantially flat or slightly concave profile of compression line 4 on the side facing counter-roller 31 eliminates thrust on material 2 which may result in the thinner portion of the material being brought into contact with print roller 30.

Print roller 30 therefore only contacts the surface of material 2 outside compression line 4, which therefore appears as a sharp “negative-printed” line on the material.

This property of compression creasing may, in a preferred embodiment of the present invention, be exploited to obtain an optically detectable register mark corresponding perfectly with compression lines 4. For example, with reference to FIGS. 1 and 2, register mark 18 may be defined by a rectangular area 36 printed on the portion of material 2 eventually defining the bottom of finished package 17. Area 36 encloses part of compression lines 4, so as to define with them, by contrast, a broken, substantially Z-shaped, “negative-printed” register line 37 comprising a first and a second segment 37a, 37b parallel to each other and perpendicular to the feed direction of web 3 on machine 6, and a segment 37c sloping with respect to segments 37a, 37b.

Consequently, as web 3 is fed through machine 6, register mark 18 can be detected by one or more optical sensors 16 for controlling the position of web 3 at a respective work station and connected to a processing and control unit 41 for controlling known devices (not shown) governing the position of web 3.

Using a Z-shaped register line 37, the position of web 3 can be controlled both in the feed direction and transversely, e.g. to correct the transverse position of the still-flat web—to perform auxiliary operations such as cutting and applying removable tongues or opening devices—or to correct the angular position of tube 9.

Optical sensor 16, in fact, successively detects first segment 37a, sloping segment 37c, and second segment 37b of the line; control unit 41 calculates a first time T1 between detection of first segment 37a and sloping segment 37c, and a second time T2 between detection of sloping segment 37c and second segment 37b; and the transverse position error of web 3 can be calculated and corrected on the basis of the T1 to T2 ratio. More specifically, if sensor 16 is located in the mid-plane of register marks 18, in the correct or reference position of web 3, the correct transverse position of the web corresponds to a T1/T2 ratio of 1. If the ratio is less than or greater than 1, the web can be moved transversely in known manner in the appropriate direction to reduce the position error.

In the FIG. 5 variation, register mark 18 is defined by compression lines 4 formed solely for that purpose, i.e. playing no part in the formation of the package, and conveniently comprises a square printed area 36 enclosing four compression lines 37d forming a square, and a compression line 37e along the diagonal of the square.

The mark can thus be “read” in exactly the same way as Z-shaped register line 37, but, being square, can be read in two perpendicular material feed directions X, Y with respect to an optical sensor 16.

This may be useful, for example, to use mark 18 as a register on a unit for applying opening devices to finished packages 17, and on which the packages are fed forward differently oriented.

Clearly, changes may be made to material 2 as described herein without, however, departing from the scope defined in the accompanying claims.

In particular, as opposed to or in addition to marks 18, the material may be provided with conventional, printed, optically detectable register marks, so that material 2 may be used (or also used) on conventional machines.

Marks 18 may also be “read” directly, i.e. without a contrasting printed area.

1. A packaging sheet material for packaging pourable food products and having a number of fold lines wherein said fold lines are compression lines having a recessed profile on a first face of the material, and a nonconvex profile on a second face of said material.

2. A material as claimed in claim 1, comprising at least one optically detectable register mark on said first face.

3. A material as claimed in claim 1, wherein said register mark is at least partly defined by said compression lines.

4. A material as claimed in claim 1, having a decoration printed on said first face.

5. A material as claimed in claim 4, wherein said decoration comprises at least one printed area at least partly enclosing said compression lines and defining, with them and by contrast, said register mark.

6. A material as claimed in claim 1, wherein said register mark comprises at least two parallel segments, and a sloping segment interposed between the parallel segments.

7. A material as claimed in claim 6, wherein said register mark comprises four segments arranged in the form of a square, and a sloping segment along the diagonal of the square.

8. A material as claimed in claim 1, wherein said compression lines are defined, towards said first face of the material, by steep sides.

9. A material as claimed in claim 1, wherein said compression lines are of a depth ranging between 30% and 60% of the thickness of the material.

10. A material as claimed in claim 3, wherein said compression lines are of a depth equal to about 50% of the thickness of the material.

11. A method of producing a sheet material for packaging food products and having a number of fold lines comprising a compression creasing step in which said material is compressed between a creasing roller, acting on a first face of said material and having a number of projections for producing said fold lines in the form of compression lines, and a substantially smooth reaction roller acting on a second face of said material.

12. A method as claimed in claim 11, wherein said projections of said creasing roller are of a height ranging between 50 and 90% of the thickness of said material.

13. A method as claimed in claim 12, wherein said projections of said creasing roller are of a height substantially equal to 80% of the thickness of said material.

14. A method as claimed in claim 11, comprising a printing step to print a decoration on said first face of said material.

15. A method as claimed in claim 14, wherein said printing step produces a printed area enclosing at least a portion of said compression lines to define an optically detectable register mark.
